(19) United States
(12) Patent Application Publication
(10) Pub. No.: US 2016/0117079 A1
(43) Pub. Date: Apr. 28, 2016

(54) METHOD AND APPARATUS FOR DISPLAYING APPLICATION ICONS ON TERMINAL

(71) Applicant: Tencent Technology (Shenzhen) Company Limited, Shenzhen City (CN)

(72) Inventor: Zhe HUANG, Shenzhen (CN)

(21) Appl. No.: 14/983,284

(22) Filed: Dec. 29, 2015

Related U.S. Application Data
(63) Continuation of application No. PCT/CN2015/074524, filed on Mar. 18, 2015.

(30) Foreign Application Priority Data
Mar. 18, 2014 (CN) 201410101792.1

(51) Int. Cl. G06F 3/0481; H04M 1/725; G06F 3/0483

(52) U.S. Cl. CPC G06F 3/04817; G06F 3/0483; H04M 1/72583

(57) ABSTRACT

The present disclosure discloses a method and an apparatus for displaying application icons on a terminal. The method comprises: receiving, on a terminal, an application icon adjustment request, the application icon adjustment request being used for requesting categorized display of application icons corresponding to applications installed on the terminal; acquiring categorization information of the applications in response to the application icon adjustment request; and displaying, according to the categorization information, the application icons of the applications by category on the terminal. The present disclosure solves the technical problem of a long adjustment time caused by that display positions of application icons on a terminal need to be adjusted manually in the existing technology, and achieves technical effects of automatic adjustment by a system, a reduction in adjustment time, and an increase in adjustment efficiency.

### CROSS REFERENCE TO RELATED APPLICATION

This application is claims the benefit and priority of International Application No. PCT/CN2015/074524, filed on Mar. 18, 2015, which claims priority to Chinese Application No. 2014101017921, filed Mar. 18, 2014. The entire disclosures of each of the above applications are incorporated herein by reference.

### FIELD OF THE TECHNOLOGY

The present disclosure relates to the field of computers, and in particular, to a method and an apparatus for displaying application icons on a terminal.

### BACKGROUND OF THE DISCLOSURE

With the rapid development and popularization of communications technologies, particularly, 3G/4G technologies, and a significant reduction in costs and power consumption of high-performance embedded chips, wireless intelligent terminals are gradually becoming essential devices of the vast majority of users. While the performance of wireless terminals advances incessantly, the speed of applications developed by developers also increases exponentially, and with more and more options, the number of applications that users install on wireless terminals also increases dramatically. Meanwhile, how to manage these applications rationally so that display positions of these applications facilitate use by users becomes a more and more prominent problem.

In a conventional application management system, application management manners mainly include: managing display positions of applications by sorting the applications according to an alphabetical order of application names, time when the applications are installed or used, sizes of the applications, or the like. All these management manners actually sort applications by using computer logic, and in all the existing application management manners, common users need to spend time in adjusting display positions of applications, and therefore, these application management manners have time costs, and are low in operation efficiency and inconvenient to use.

At present, there is no effective solution to the foregoing problem.

### SUMMARY

Embodiments of the present invention provide a method and an apparatus for displaying application icons on a terminal, so as to solve the technical problem of a long adjustment time caused by that display positions of application icons on a terminal need to be adjusted manually in the existing technology.

According to an aspect of the embodiments of the present invention, a method for displaying application icons on a terminal is provided, including: receiving, on a terminal, an application icon adjustment request, the application icon adjustment request being used for requesting categorized display of application icons corresponding to applications installed on the terminal; acquiring categorization information of the applications in response to the application icon adjustment request; and displaying, according to the categorization information, the application icons of the applications by category on the terminal.

Optionally, the acquiring categorization information of the applications in response to the application icon adjustment request includes: sending application identifiers of the applications from the terminal to a server, and receiving the categorization information found on the basis of the application identifiers and returned by the server; or acquiring the categorization information from a database of the terminal on the basis of application identifiers of the applications.

Optionally, the displaying, according to the categorization information, the application icons of the applications by category on the terminal includes: determining whether the application icon adjustment request is used for categorized display of all application icons on the terminal; displaying, if it is determined that the application icon adjustment request is used for categorized display of all application icons on the terminal, the application icons of all the applications on the terminal by category according to the categorization information; or displaying, on the terminal by category according to the categorization information, application icons of applications that meet a predetermined condition among all the applications if it is determined that the application icon adjustment request is not used for categorized display of all application icons on the terminal, the predetermined condition including at least one of the following: the application icon of the application is not displayed on a default screen of the terminal, and the application does not belong to any existing category.

Optionally, the displaying, on the terminal by category according to the categorization information, application icons of applications that meet a predetermined condition among all the applications includes: determining, according to the categorization information, a category corresponding to each application that meets the predetermined condition; determining whether the categories corresponding to the applications meeting the predetermined condition are the same as an existing category on the terminal; displaying, if the categories corresponding to the applications meeting the predetermined condition are the same as the existing category on the terminal, the application icons of the applications meeting the predetermined condition in a same folder or multiple subfolders of a same folder with application icons in the existing category; or displaying separately an application icon of an application that does not belong to a same category as other applications among the applications meeting the predetermined condition, and displaying, in a same folder or multiple subfolders of a same folder, application icons of applications that belong to a same category among the applications meeting the predetermined condition, if the categories corresponding to the applications that meet the predetermined condition are not the same as the existing category on the terminal.

Optionally, the displaying, on the terminal by category according to the categorization information, application icons of applications that meet a predetermined condition among all the applications includes: determining, according to the categorization information, a category corresponding to each application that meets the predetermined condition; determining whether the categories corresponding to the applications meeting the predetermined condition are the same as an existing category on the terminal; determining, if the categories corresponding to the applications meeting the predetermined condition are the same as the existing category on the terminal, whether all application icons in the existing category belong to a same category, and displaying, if all the application icons in the existing category belong to a same category, the application icons of the applications meeting the predetermined condition in a same folder or multiple subfolders of a same folder with the application icons in the existing category; or displaying separately an application icon of an application that does not belong to a same category as other applications among the applications meeting the predetermined condition, and displaying, in a same folder or multiple subfolders of a same folder, application icons of applications that belong to a same category among the applications meeting the predetermined condition, if not all application icons in the existing category belong to a same class; or displaying separately an application icon of an application that does not belong to a same category as other applications among the applications meeting the predetermined condition, and displaying, in a same folder or multiple subfolders of a same folder, application icons of applications that belong to a same category among the applications meeting the predetermined condition, if the categories corresponding to the applications meeting the predetermined condition are not the same as the existing category on the terminal.

Optionally, the displaying, according to the categorization information, the application icons of the applications by category on the terminal includes: determining, according to the categorization information, a category corresponding to each application; categorizing the applications into the corresponding categories, where if an application among the applications corresponds to multiple categories, the number of applications in each category of the multiple categories is acquired, and said application is categorized into a category having the largest number of applications among the multiple categories, and if an application among the applications corresponds to one category, said application is categorized into said category; and displaying the applications by category on the terminal according to the categories.

Optionally, the displaying the applications by category on the terminal according to the categories includes: displaying, in a same folder, application icons of applications that belong to a same category having two or more applications; and displaying separately an application icon of an application that belongs to a category having less than two applications.

According to another aspect of the embodiments of the present invention, an apparatus for displaying application icons on a terminal is further provided, including: a receiving unit, configured to receive, on a terminal, an application icon adjustment request, the application icon adjustment request being used for requesting categorized display of application icons corresponding to applications installed on the terminal; an acquiring unit, configured to acquire categorization information of the applications in response to the application icon adjustment request; and a display unit, configured to display, according to the categorization information, the application icons of the applications by category on the terminal.

Optionally, the acquiring unit includes: a communications module, configured to send application identifiers of the applications from the terminal to a server, and receive the categorization information found on the basis of the application identifiers and returned by the server; or an acquiring module, configured to acquire the categorization information from a database of the terminal on the basis of application identifiers of the applications.

Optionally, the display unit includes: a judging module, configured to determine whether the application icon adjustment request is used for categorized display of all application icons on the terminal; a first display module, configured to display, if it is determined that the application icon adjustment request is used for categorized display of all application icons on the terminal, the application icons of all the applications on the terminal by category according to the categorization information; and a second display module, configured to display, on the terminal by category according to the categorization information, application icons of applications that meet a predetermined condition among all the applications if it is determined that the application icon adjustment request is not used for categorized display of all application icons on the terminal, the predetermined condition including at least one of the following: the application icon of an application is not displayed on the default screen of the terminal, and the application does not belong to any existing category.

Optionally, the second display module includes: a first determining sub-module, configured to determine, according to the categorization information, a category corresponding to each application that meets the predetermined condition; a first judging sub-module, configured to determine whether the categories corresponding to the applications meeting the predetermined condition are the same as an existing category on the terminal; a first display sub-module, configured to display, if it is determined that the categories corresponding to the applications meeting the predetermined condition are the same as the existing category on the terminal, the application icons of the applications meeting the predetermined condition in a same folder or multiple subfolders of a same folder with application icons in the existing category; and a second display sub-module, configured to display separately an application icon of an application that does not belong to a same category as other applications among the applications meeting the predetermined condition, and display, in a same folder or multiple subfolders of a same folder, application icons of applications that belong to a same category among the applications meeting the predetermined condition, if it is determined that the categories corresponding to the applications meeting the predetermined condition are not the same as the existing category on the terminal.

Optionally, the second display module includes: a second determining sub-module, configured to determine, according to the categorization information, a category corresponding to each application that meets the predetermined condition; a second judging sub-module, configured to determine whether the categories corresponding to the applications meeting the predetermined condition are the same as an existing category on the terminal; a third display sub-module, configured to determine, if the categories corresponding to the applications meeting the predetermined condition are the same as the existing category on the terminal, whether all application icons in the existing category belong to a same category, and display, if all the application icons in the existing category belong to a same category, the application icons of the applications meeting the predetermined condition in a same folder or multiple subfolders of a same folder with the application icons in the existing category; or display separately an application icon of an application that does not belong to a same category as other applications among the applications meeting the predetermined condition, and display, in a same folder or multiple subfolders of a same folder, application icons of applications that belong to a same category among the applications meeting the predetermined condition, if not all application icons in the existing category belong to a same category; or display separately an application icon of an application that does not belong to a same category as other applications among the applications meeting the predetermined condition, and display, in a same folder or multiple subfolders of a same folder, application icons of applications that belong to a same category among the applications meeting the predetermined condition, if the categories corresponding to the applications meeting the predetermined condition are not the same as the existing category on the terminal.

Optionally, the display unit includes: a determining module, configured to determine, according to the categorization information, a category corresponding to each application; a categorization module, configured to categorize the applications into the corresponding categories, where if an application among the applications corresponds to multiple categories, the number of applications in each category of the multiple categories is acquired, and said application is categorized into a category having the largest number of applications among the multiple categories, and if an application among the applications corresponds to one category, said application is categorized into said category; and a third display module, configured to display the applications by category on the terminal according to the categories.

Optionally, the third display module includes: a fourth display sub-module, configured to display, in a same folder, application icons of applications that belong to a same category having two or more applications; and a fifth display sub-module, configured to display separately an application icon of an application that belongs to a category having less than two applications.

In the embodiments of the present invention, rational display of application icons on a terminal is implemented by means of automatic adjustment. Specifically, after a terminal receives an application icon adjustment request, categorization information, which is provided by a server or a database of the terminal, of applications corresponding to the application icon adjustment request is acquired, and application icons on the terminal are displayed by category according to the categorization information; further, it needs to be determined whether the application icon adjustment request is used for categorized display of all application icons, whether a predetermined condition is met, and whether corresponding categories are the same as an existing category on the terminal, thereby displaying the application icons on the terminal rapidly and rationally. Therefore, the present disclosure achieves technical effects of automatic adjustment by a system, a reduction in adjustment time, and an increase in adjustment efficiency, thereby solving the technical problem of a long adjustment time caused by that display positions of application icons on a terminal need to be adjusted manually in the existing technology.

### BRIEF DESCRIPTION OF THE DRAWINGS

The accompanying drawings described herein are used to provide further comprehension of the present disclosure, and is a part of the present application. Schematic embodiments of the present invention and the description thereof are used to illustrate the present disclosure, but do not constitute any improper limit to the present disclosure. In the accompanying drawings:

FIG. 1 is a flowchart of an optional method for displaying application icons on a terminal according to an embodiment of the present invention;

FIG. 2 is a schematic diagram of an optional display manner of application icons on a terminal according to an embodiment of the present invention;

FIG. 3 is a flowchart of another optional method for displaying application icons on a terminal according to an embodiment of the present invention;

FIG. 4 is a schematic diagram of another optional display manner of application icons on a terminal according to an embodiment of the present invention;

FIG. 5 is a flowchart of yet another optional method for displaying application icons on a terminal according to an embodiment of the present invention;

FIG. 6 is a schematic diagram of yet another optional display manner of application icons on a terminal according to an embodiment of the present invention;

FIG. 7 is a flowchart of yet another optional method for displaying application icons on a terminal according to an embodiment of the present invention;

FIG. 8 is a schematic diagram of yet another optional display manner of application icons on a terminal according to an embodiment of the present invention;

FIG. 9 is a flowchart of yet another optional method for displaying application icons on a terminal according to an embodiment of the present invention;

FIG. 10 is a schematic diagram of an optional apparatus for displaying application icons on a terminal according to an embodiment of the present invention;

FIG. 11 is a schematic diagram of another optional apparatus for displaying application icons on a terminal according to an embodiment of the present invention; and

FIG. 12 is a schematic diagram of yet another optional apparatus for displaying application icons on a terminal according to an embodiment of the present invention.

### DESCRIPTION OF EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

It should be noted that, the terms such as “first” and “second” in the specification, the claims, and the foregoing accompanying drawings of the present invention are used to distinguish similar objects, and are not necessarily used to describe a specific sequence or specific precedence order. It should be understood that, data used in this manner may be interchanged in a proper circumstance, so that the embodiments of the present invention described herein can be implemented in other sequences than the sequence shown in the drawings or described herein. In addition, the terms “include”, “have”, any variants thereof are intended to cover a non-exclusive inclusion, for example, a process, method, system, product, or device that includes a series of steps or units is not necessarily limited to the steps or units specified expressly, but may include other steps or units which are not specified expressly or may include inherent steps or units of the process, method, product or device.

### Embodiment 1

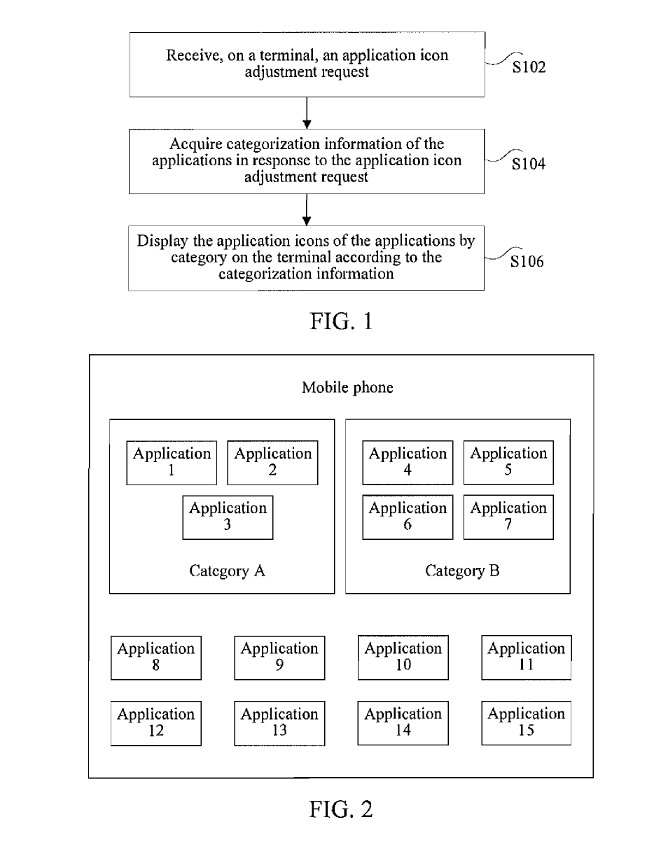

According to this embodiment of the present invention, a method for displaying application icons on a terminal is provided. As shown in FIG. 1, the method includes:

S102: Receive, on a terminal, an application icon adjustment request.

Optionally, in this embodiment, the foregoing situation may include, but is not limited to, being applied to adjustment of display positions of application icons on a terminal, and the foregoing terminal includes, but is not limited to at least one of the following: a mobile phone, a notebook computer, and a tablet computer.

For example, as shown in FIG. 2, it is assumed that 15 applications are installed on the mobile phone, namely, application 1 to application 15; application 1, application 2 and application 3 belong to category A, and therefore, application 1, application 2 and application 3 are categorized into category A, and application icons of application 1, application 2 and application 3 are displayed in a same folder, where the name of the folder may be, but is not limited to, the name of category A (for example, social messaging); application 4, application 5, application 6 and application 7 belong to category B, and therefore, application 4, application 5, application 6 and application 7 are categorized into category B, and application 4, application 5, application 6 and application 7 are displayed in a same folder, where the name of the folder may be, but is not limited to, the name of category B (for example, news); and other applications are separately displayed on the mobile phone. Based on the foregoing condition, the mobile phone may receive an application icon adjustment request used for requesting adjustment of the application icons of the 15 applications described above. The above is merely an example, and the present application is not limited thereto.

Optionally, in this embodiment, the application icon adjustment request is used for requesting categorized display of application icons of applications installed on the terminal. The application icon adjustment request in this embodiment may further be used for requesting categorized display of all application icons on the terminal.

S104: Acquire categorization information of the applications in response to the application icon adjustment request.

Optionally, in this embodiment, the foregoing categorization information may be obtained in at least one of the following means: searching by a server, or searching a database of the terminal, but means for obtaining the categorization information is not limited thereto. Optionally, the application in this embodiment may correspond to one or more pieces of categorization information, for example, categorization information of a video application includes but is not limited to the following: the application is developed by company N1, the application is categorized as a player application, the application needs network connection, and the like. The above is merely an example, and the present application is not limited thereto.

For example, as shown in FIG. 2, application 1 is a video application, application 2 is an audio application, and application 3 is a local video player; after receiving an application icon adjustment request corresponding to the foregoing three applications, the mobile phone acquires categorization information of the foregoing applications in response to the request, where categorization information of the video application includes but is not limited to the following: the application is developed by company N1, the application is categorized as a player application, and the application needs network connection; categorization information of the audio application includes the following: the application is developed by company N2, the application is categorized as a player application, and the application needs network connection; categorization information of the local video player includes the following: the application is developed by company N3, the application is categorized as a player application, and the application does not need network connection.

S106: Display the application icons of the applications on the terminal by category according to the categorization information.

Optionally, the manner for displaying the application icon in this embodiment may include but is not limited to at least one of the following: displaying the application icon in a folder, and displaying the application icon on the terminal separately.

For example, as shown in FIG. 2, based on the description above, application 1 is a video application, application 2 is an audio application, and application 3 is a local video player; according to the categorization information of the foregoing applications acquired by the mobile phone, the three applications all belong to “player applications”, and therefore, the foregoing three applications may be categorized into a same category, namely, a folder of category A, for example, category A is named “player applications”. Further, based on the same categorization principle, it is determined that application 5 to application 8 belong to a same category (for example, belong to “game applications”), namely, category B shown in FIG. 2, and therefore, the foregoing applications are all displayed in a folder of category B (for example, category B is named “game applications”) on the terminal.

For another example, as shown in FIG. 2, it can be learned according to the acquired categorization information that, application 8 to application 15 do not belong to a same category, and therefore, application 8 to application 15 are separately displayed on the mobile phone.

In this embodiment provided by the present application, after the application adjustment request is received on the terminal, the categorization information of the corresponding applications is acquired to implement categorized display of the application icons, which implements automatic adjustment of display of the application icons according to the categorization information of the applications, thereby reducing an adjustment time for users, and improving user experience.

As an optional solution, step S104, namely, acquiring categorization information of the applications in response to the application icon adjustment request, includes:

S1: Send application identifiers of the applications from the terminal to a server, and receive the categorization information found on the basis of the application identifiers and returned by the server.

Optionally, in this embodiment, categorization information in a database of the terminal is updated and modified if categorization information acquired from the server is different from the categorization information in the database of the terminal.

Optionally, in this embodiment, when the terminal has network connection, the terminal may acquire categorization information of applications, which is requested by the application icon adjustment request, by using the server. For example, as shown in FIG. 2, an application identifier of application 1 on the mobile phone may include an installation package name Apk1 and/or application name AppN1 of application 1, an application identifier of application 2 may include an installation package name Apk2 and/or application name AppN2 of application 2, and an application identifier of application 3 may include an installation package name Apk3 and/or application name AppN3 of application 3. The application identifiers of the foregoing applications are sent from the mobile phone to the server, and the server searches for corresponding categorization information according to the application identifiers, and then returns the obtained categorization information of the applications to the mobile phone.

S2: Acquire the categorization information from a database of the terminal on the basis of application identifiers of the applications.

Optionally, in this embodiment, when the terminal does not have network connection, the terminal acquires the categorization information from the database of the terminal on the basis of the application identifiers of the applications. For example, as shown in FIG. 2, an application identifier of application 1 on the mobile phone may include an installation package name Apk1 and/or application name AppN1 of application 1, an application identifier of application 2 may include an installation package name Apk2 and/or application name AppN2 of application 2, and an application identifier of application 3 may include an installation package name Apk3 and/or application name AppN3 of application 3. Assuming that 5000 pieces of categorization information are stored in the database of the mobile phone, the mobile phone retrieves corresponding application identifiers in the 5000 pieces of categorization information, to find the application identifiers of the foregoing applications, and if the corresponding application identifiers are found, the mobile phone acquires corresponding categorization information according to the application identifiers.

In this embodiment provided by the present application, when network connection is available, the categorization information for categorized display may be acquired by the server through searching on the basis of the application identifiers of the applications; and when network connection is unavailable, the corresponding categorization information is acquired from the database of the terminal on the basis of the corresponding application identifiers. In this way, high accuracy of categorization is ensured when network connection is available, and a high categorization speed is ensured when network connection is unavailable.

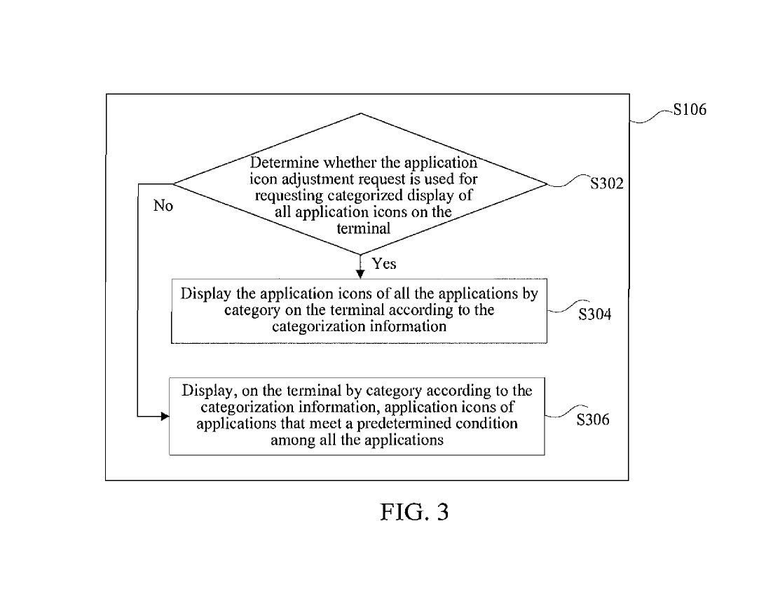

As an optional solution, as shown in FIG. 3, step S106, namely, displaying the application icons of the applications on the terminal by category according to the categorization information includes:

S302: Determine whether the application icon adjustment request is used for categorized display of all application icons on the terminal.

Optionally, in this embodiment, all application icons may be, but are not limited to, application icons corresponding to all applications already installed on the terminal. For example, as shown in FIG. 2, it is assumed that 15 applications are installed on the mobile phone, namely, application 1 to application 15; application 1, application 2 and application 3 belong to category A, and therefore, application 1, application 2 and application 3 are categorized into category A, and application icons of application 1, application 2 and application 3 are displayed in a same folder, where the name of the folder may be, but is not limited to, the name of category A (for example, social messaging); application 4, application 5, application 6 and application 7 belong to category B, and therefore, application 4, application 5, application 6 and application 7 are categorized into category B, and application 4, application 5, application 6 and application 7 are displayed in a same folder, where the name of the folder may be, but is not limited to, the name of category B (for example, news); and other applications are separately displayed on the mobile phone. Based on the foregoing condition, after receiving the application icon adjustment request, the mobile phone needs to determine whether the application adjustment request is used for requesting categorized display of application icons of all applications installed on the mobile phone, that is, categorized display of the application icons of application 1 to application 15.

S304: Display, if it is determined that the application icon adjustment request is used for categorized display of all application icons on the terminal, the application icons of all the applications on the terminal by category according to the categorization information.

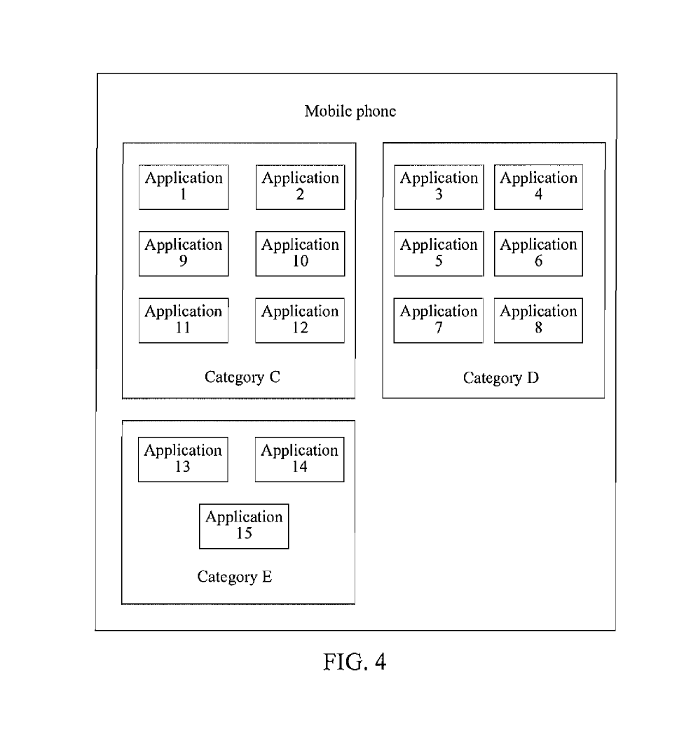

For example, if it is determined that the application icon adjustment request is used for categorized display of all application icons on the terminal, the application icons of the foregoing 15 applications are displayed by category on the terminal according to the acquired categorization information. Specifically, by using categorized display according to the categorization information “whether the application needs network connection” as an example, all the application icons are displayed by category. For example, as shown in FIG. 4, application 1, application 2, and application 9 to application 12 need to be used when network connection is available, and therefore are categorized into category C, and the application icons of application 1, application 2, and application 9 to application 12 are displayed in one folder, where the name of the folder may be, but is not limited to, the name of category C (for example, online applications); application 3 to application 8 can be used without network connection, and therefore are categorized into category D, and the application icons of application 3 to application 8 are displayed in one folder, where the name of the folder may be, but is not limited to, the name of category D (for example, offline applications); the remaining application 13 to application 15 can be used no matter network connection is available or not, and therefore are categorized into category E, and the application icons of application 13 to application 15 are displayed in one folder, where the name of the folder may be, but is not limited to, the name of category E (for example, optional applications). The above is merely an example, and categorized display of all application icons is not limited to being performed according to one type of categorization information; however, categorization principles are the same, and the present application does not provide detailed description herein again.

S306: Display, on the terminal by category according to the categorization information, application icons of applications that meet a predetermined condition among all the applications if it is determined that the application icon adjustment request is not used for categorized display of all application icons on the terminal.

Optionally, the predetermined condition in this embodiment includes at least one of the following: the application icon of the applications is not displayed on a default screen of the terminal, and the application does not belong to any existing category. Optionally, the default screen in this embodiment may be, but is not limited to, a screen that a user can quickly reach by touching a shortcut key, for example, home screen that the user can reach by touching “HOME”.

Optionally, in this embodiment, when an application on the terminal does not meet the predetermined condition, for example, the application icon of the application is displayed on the default screen of the mobile phone, or the application belongs to an existing category on the mobile phone, the application does not participate in the subsequent categorized display operation, and the original display position is reserved.

For example, if it is determined that the application icon adjustment request is not used for categorized display of all application icons on the mobile phone, and the foregoing applications all meet the predetermined condition, the application icons of the applications that meet the predetermined condition are displayed by category according to the categorization information.

In this embodiment provided by the present application, by determining whether the application icon adjustment request is used for categorized display of all application icons on the terminal, application icons on the terminal are categorized separately according to requirements, thereby providing more display manners for users according to different user requirements.

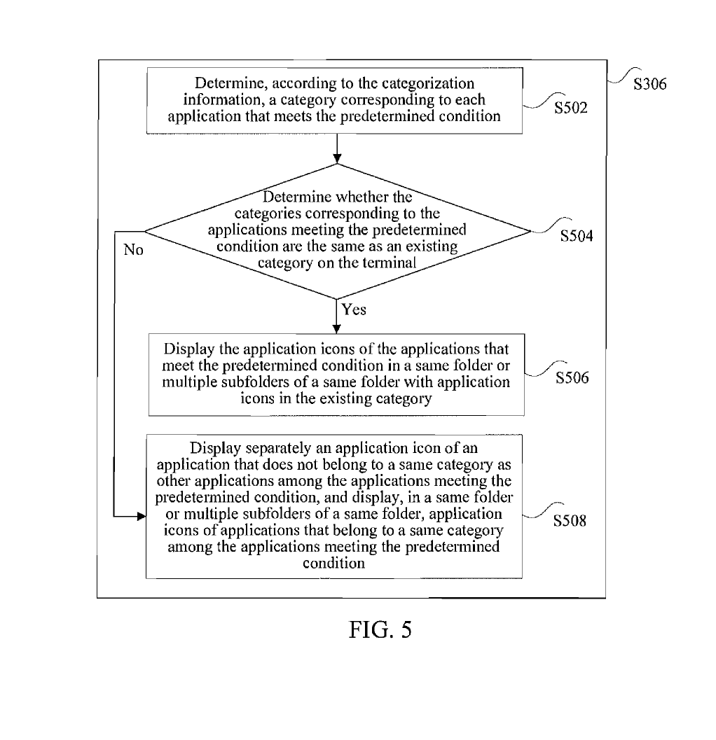

As an optional solution, as shown in FIG. 5, step S306, namely, displaying, on the terminal by category according to the categorization information, application icons of applications that meet a predetermined condition among all the applications includes:

S502: Determine, according to the categorization information, a category corresponding to each application that meets the predetermined condition.

Optionally, in this embodiment, each application that meets the condition may correspond to one or more categories. For example, as shown in FIG. 2, applications that meet the predetermined condition are application 8 to application 15, where the categorization information of application 8 to application 15 and the category corresponding to each application meeting the predetermined condition may be as shown in Table 1 below.

TABLE 1

| | Categorization | |
|---|---|---|
| Application | information | Category |
| Application 8 | Category A | Category A |
| | Category B | |
| | Category C | |
| Application 9 | Category B | Category B |
| | Category D | |
| Application 10 | Category A | Category A |
| | Category C | |
| Application 11 | Category A | Category A |
| | Category E | |
| Application 12 | Category E | Category E |
| Application 13 | Category F | Category F |
| Application 14 | Category G | Category G |
| Application 15 | Category H | Category H |

S504: Determine whether the categories corresponding to the applications meeting the predetermined condition are the same as an existing category on the terminal.

For example, as shown in FIG. 2, applications meeting the predetermined condition are application 8 to application 15, and it is determined whether categories of these applications are the same as the existing categories on the mobile phone. More specifically, the existing categories on the mobile phone are category A and category B, and it is determined according to the categorization information of application 8 to application 15 that application 8 to application 11 separately belong to the existing category A and category B, while application 12 to application 15 belong to categories that do not exist on the mobile phone.

S506: Display, if the categories corresponding to the applications meeting the predetermined condition are the same as the existing category on the terminal, the application icons of the applications meeting the predetermined condition in a same folder or multiple subfolders of a same folder with application icons in the existing category.

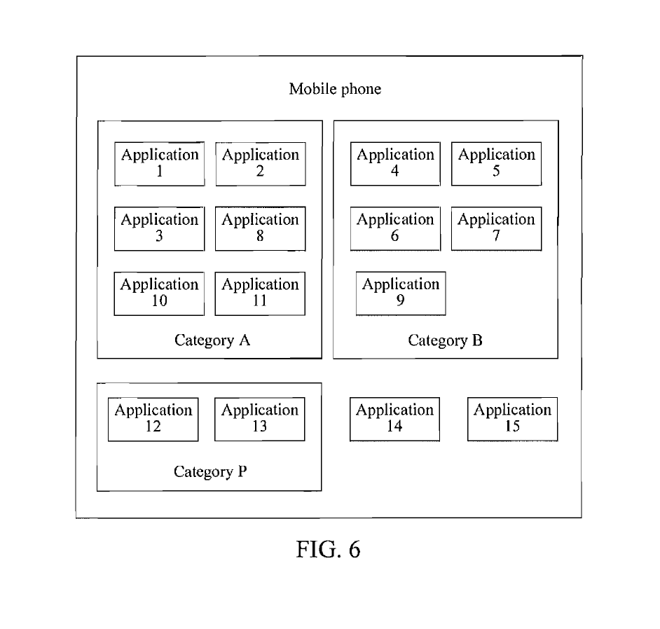

Optionally, in this embodiment, a condition for creating a subfolder includes, but is not limited to, the following two points: first, the number of applications in each subfolder should be greater than a value (for example, 4), and second, the maximum number of subfolders into which a folder is divided should be less than a value (for example, 6). Optionally, multiple applications in a same folder may be displayed in multiple subfolders of the folder in different manners, where the manner includes, but is not limited to: randomly displaying multiple applications, which are in a same folder, in multiple subfolders of the folder, or displaying multiple applications, which are in a same folder, in multiple subfolders of the folder according to an alphabetic order of application names. For example, as shown in Table 1 and FIG. 6, the categories corresponding to application 8 to application 11 among application 8 to application 15 that meet the predetermined condition are separately the same as category A and category B existing on the mobile phone, and in this case, the application icons of application 8 to application 11 that meet the predetermined condition are each displayed in a same folder or multiple subfolders of a same folder with the application icons in the existing category.

S508: Display separately an application icon of an application that does not belong to a same category as other applications among the applications meeting the predetermined condition, and display, in a same folder or multiple subfolders of a same folder, application icons of applications that belong to a same category among the applications meeting the predetermined condition, if the categories corresponding to the applications that meet the predetermined condition are not the same as the existing category on the terminal.

For example, as shown in Table 1 and FIG. 6, categories corresponding to application 12 to application 15 among application 8 to application 15 that meet the predetermined condition are different from category A and category B existing on the mobile phone, and in this case, application icons of applications that do not belong to a same category as other applications among application 12 to application 15 meeting the predetermined condition are displayed separately, for example, application 14 and application 15 do not belong to a same category as other applications, and therefore are displayed separately. Application icons of applications that belong to a same category among the applications meeting the predetermined condition are displayed in a same folder or multiple subfolders of a same folder. For example, application 12 and application 13 belong to a same category P, while the category P is not an existing category on the terminal, and in this case, the application icons of application 12 and application 13 are displayed in a same folder, and the name of the folder may be, but is not limited to, the name of category P (for example, instant messaging).

In this embodiment of the present application, it is determined whether categories corresponding to the applications meeting the predetermined condition are the same as an existing category on the terminal; if the category of an application is the same as the existing category, the application icon of application is displayed in a same folder with application icons in the existing category, and the application icon of an application that belongs to a different category is displayed separately. In this manner, when display positions of application icons are adjusted, the display positions of the application icons that have been categorized by the user can be reserved, so that the adjustment does not affect the original use habit of the user.

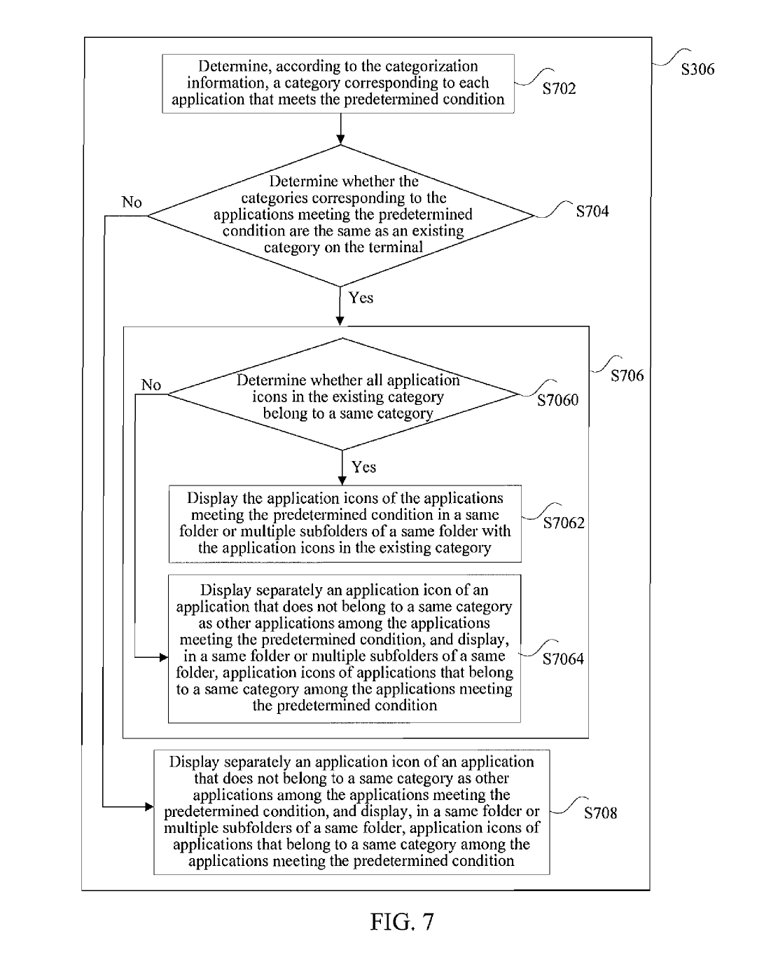

As an optional solution, as shown in FIG. 7, step S306, namely, displaying, on the terminal by category according to the categorization information, application icons of applications that meet a predetermined condition among all the applications includes:

S702: Determine, according to the categorization information, a category corresponding to each application that meets the predetermined condition.

S704: Determine whether the categories corresponding to the applications meeting the predetermined condition are the same as an existing category on the terminal.

S706: Perform the following steps if the categories corresponding to the applications meeting the predetermined condition are the same as the existing category on the terminal:

S7060: Determine whether all application icons in the existing category belong to a same category.

Optionally, in this embodiment, all applications in the existing category may belong to a same category, for example, as shown in FIG. 2, applications in category A are all player applications; or, not all applications in the existing category belong to a same category, for example, as shown in FIG. 2, applications in category B include different utilities such as communication application and navigation application. Therefore, in this embodiment, it needs to be determined whether all application icons in the existing category belong to a same category.

S7062: Display, if all the application icons in the existing category belong to a same category, the application icons of the applications meeting the predetermined condition in a same folder or multiple subfolders of a same folder with the application icons in the existing category.

For example, as shown in FIG. 2 and FIG. 6, if all the application icons in the existing category belong to a same category, for example, all applications in category A are “player applications”, applications that meet the predetermined condition and belong to category A, such as application 8, application 10 and application 11, are displayed in a same folder or multiple subfolders of a same folder with the application icons in the existing category A.

S7064: Display separately an application icon of an application that does not belong to a same category as other applications among the applications meeting the predetermined condition, and display, in a same folder or multiple subfolders of a same folder, application icons of applications that belong to a same category among the applications meeting the predetermined condition, if not all application icons in the existing category belong to a same category.

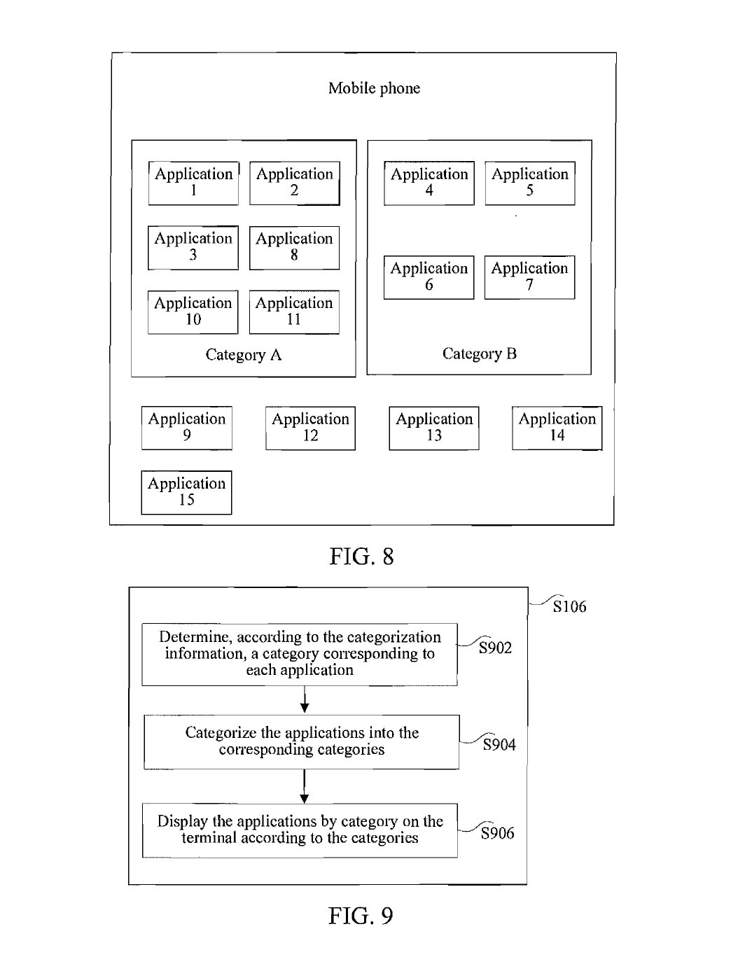

For example, as shown in FIG. 2 and FIG. 8, not all application icons in the existing category belong to a same category, for example, applications in category B include different utilities such as communication application and navigation application, where an application that meets the predetermined condition, such as application 9, belongs to category B according to the categorization information; however, it needs to be further determined herein whether application 9 belongs to a same category as other applications not participating in the categorization, and if application 9 does not belong to a same category as other applications not participating in the categorization, as shown in FIG. 8, the application icon of application 9 is displayed separately; otherwise, if application 9 belongs to a same category as other applications not participating in the categorization, application 9 is merged with other applications in the same category, and the application icon of application 9 is displayed in a same folder or subfolder as other applications.

S708: Display separately an application icon of an application that does not belong to a same category as other applications among the applications meeting the predetermined condition, and display, in a same folder or multiple subfolders of a same folder, application icons of applications that belong to a same category among the applications meeting the predetermined condition, if the categories corresponding to the applications meeting the predetermined condition are not the same as the existing category on the terminal.

In this embodiment provided by the present application, after it is determined whether the categories corresponding to the applications meeting the predetermined condition are the same as an existing category on the terminal, it is further determined whether all application icons in the existing category belong to a same category, and an application meeting the predetermined condition is merged into the existing category only when it belongs to the same category as all application icons in the existing category, so that the adjustment of application icons does not affect an original use habit of a user.

As an optional solution, as shown in FIG. 9, step S106, namely, displaying the application icons of the applications on the terminal by category according to the categorization information includes:

S902: Determine, according to the categorization information, a category corresponding to each application.

For example, as shown in Table 1, it is determined according to the categorization information that application 8, application 10 and application 11 correspond to category A, application 9 corresponds to category B, and application 12 to application 15 separately correspond to category E, category F, category G, and category H.

S904: Categorize the applications into the corresponding categories.

Optionally, if an application among the applications corresponds to multiple categories, the number of applications in each category of the multiple categories is acquired, and said application is categorized into a category having the largest number of applications among the multiple categories, and if an application among the applications corresponds to one category, said application is categorized into said category.

For example, it is learned before categorized display that, application 1 to application 15 are installed on the mobile phone, where applications meeting the predetermined condition are application 8 to application 15, and categorization information of the eight applications is shown in Table 1. Optionally, in this embodiment, the categorization follows the following principle: define the category that includes the largest number of applications first. It can be learned from Table 1 that, category A includes three applications, namely, application 8, application 10, and application 11; category B includes two applications, namely, application 8 and application 9; category C includes two applications, namely, application 1 and application 10; category D includes one application, namely, application 9; category E includes two applications, namely, application 11 and application 12; and category F to category H each include one application, namely, application 13 to application 15, respectively. It is easy to find that category A includes the largest number of applications, and therefore, category A is defined first. A result of the categorization is as follows: category A (including application 8, application 10, and application 11), and the remaining applications are application 9, application 12, and application 13 to application 15; for application 9, the number of applications in category B is greater than the number of applications in category D, and therefore, the second category, namely, category B, is defined. In this manner, a final categorization result is as shown in the last column of Table 1.

S906: Display the applications by category on the terminal according to the categories.

For example, on the basis of the categorization principle described above, the application icons on the mobile phone are displayed by category.

In this embodiment of the present application, the application icons on the terminal are displayed automatically according to the categorization information and on the basis of the predetermined principle, and a category having the largest number of applications is defined first, thereby reducing time for adjusting display of application icons, and bringing convenience to users.

As an optional solution, step S906, namely, displaying the applications by category on the terminal according to the categories includes:

S1: Display, in a same folder, application icons of applications that belong to a same category having two or more applications.

S2: Display separately an application icon of an application that belongs to a category having less than two applications.

Optionally, in this embodiment, the number of applications in each category is controlled so as to avoid generating an oversized category or too much categories. For example, as shown in Table 1, the categories corresponding to application 12 to application 15 each include only one application, and in this case, the application icons of these applications may be displayed separately; and for a category that meets the requirement concerning the number of applications, the application icons therein are displayed in a folder denoted by the category.

Optionally, in this embodiment, an existing category may be further divided, to refine the categorization. Moreover, in this embodiment, for a principle and a method for secondary categorization, reference may be made to the primary categorization.

In this embodiment of the present application, by controlling the number of categories and the number of applications in each category, it is ensured that a user can find a needed application quickly within a shortest time; automatic adjustment by a system is implemented, an adjustment time is reduced, and adjustment efficiency is improved.

It should be noted that, for the ease of description, the foregoing method embodiments are expressed as a series of action combinations. However, a person skilled in the art should understand that the present disclosure is not limited to the described action sequence, because according to the present disclosure, some steps may be performed in other sequences or performed at the same time. Secondly, a person skilled in the art should also understand that the embodiments described in the specification are exemplary embodiments, and the involved actions and modules are not indispensable to the present disclosure.

Through the above description of the embodiment, it is apparent to a person skilled in the art that the method according to the foregoing embodiment may be accomplished by software on necessary universal hardware platforms, and definitely may also be accomplished by hardware, but in most cases, the former is a more preferable implementation manner Based on such an understanding, the technical solution of the present disclosure, or in other words, the part that makes contributions to the existing technology can be embodied in the form of a software product. The computer software product may be stored in a storage media (such as a ROM/RAM, a magnetic disk, or an optical disc), and include several instructions to instruct a computer device (which may be a personal computer, a server, or a network device) to perform the method according to the embodiments of the present invention.

### Embodiment 2

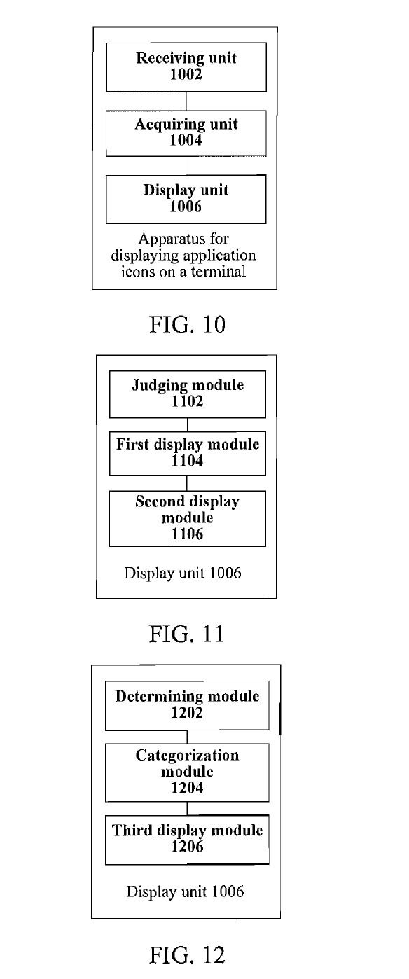

According to this embodiment of the present invention, an apparatus for displaying application icons on a terminal is further provided. As shown in FIG. 10, the apparatus includes: a receiving unit 1002, an acquiring unit 1004, and a display unit 1006.

(1) The receiving unit 1002 is configured to receive, on a terminal, an application icon adjustment request.

Optionally, in this embodiment, the foregoing situation may include, but is not limited to, being applied to adjustment of display positions of application icons on a terminal, and the foregoing terminal includes, but is not limited to at least one of the following: a mobile phone, a notebook computer, and a tablet computer.

For example, as shown in FIG. 2, it is assumed that 15 applications are installed on the mobile phone, namely, application 1 to application 15; application 1, application 2 and application 3 belong to category A, and therefore are categorized into category A, and application icons of application 1, application 2 and application 3 are displayed in a same folder, where the name of the folder may be, but is not limited to, the name of category A (for example, social messaging); application 4, application 5, application 6 and application 7 belong to category B, and therefore are categorized into category B, and application 4, application 5, application 6 and application 7 are displayed in a same folder, where the name of the folder may be, but is not limited to, the name of category B (for example, news); and other applications are separately displayed on the mobile phone. Based on the foregoing condition, the mobile phone may receive an application icon adjustment request used for requesting adjustment of the application icons of the 15 applications described above. The above is merely an example, and the present application is not limited thereto.

Optionally, in this embodiment, the application icon adjustment request is used for requesting categorized display of application icons of applications installed on the terminal. The application icon adjustment request in this embodiment may further be used for requesting categorized display of all application icons on the terminal.

(2) The acquiring unit 1004 is configured to acquire categorization information of the applications in response to the application icon adjustment request.

Optionally, in this embodiment, the foregoing categorization information may be obtained in at least one of the following means: searching by a server, or searching a database of the terminal, but means for obtaining the categorization information is not limited thereto. Optionally, the application in this embodiment may correspond to one or more pieces of categorization information, for example, categorization information of a video application includes but is not limited to the following: the application is developed by company N1, the application is categorized as a player application, the application needs network connection, and the like. The above is merely an example, and the present application is not limited thereto.

For example, as shown in FIG. 2, application 1 is a video application, application 2 is an audio application, and application 3 is a local video player; after receiving an application icon adjustment request corresponding to the foregoing three applications, the mobile phone acquires categorization information of the foregoing applications in response to the request, where categorization information of the video application includes but is not limited to the following: the application is developed by company N1, the application is categorized as a player application, and the application needs network connection; categorization information of the audio application includes the following: the application is developed by company N2, the application is categorized as a player application, and the application needs network connection; categorization information of the local video player includes the following: the application is developed by company N3, the application is categorized as a player application, and the application does need network connection.

(3) The display unit 1006 is configured to display the application icons of the applications on the terminal by category according to the categorization information.

Optionally, the manner for displaying the application icon in this embodiment may include but is not limited to at least one of the following: displaying the application icon in a folder, and displaying the application icon on the terminal separately.

For example, as shown in FIG. 2, based on the description above, application 1 is a video application, application 2 is an audio application, and application 3 is a local video player; according to the categorization information of the foregoing applications acquired by the mobile phone, the three applications all belong to “player applications”, and therefore, the foregoing three applications may be categorized into a same category, namely, a folder of category A, for example, category A is named “player applications”. Further, based on the same categorization principle, it is determined that application 5 to application 8 belong to a same category (for example, belong to “game applications”), namely, category B shown in FIG. 2, and therefore, the foregoing applications are all displayed in a folder of category B (for example, category B is named “game applications”) on the terminal.

For another example, as shown in FIG. 2, it can be learned according to the acquired categorization information that, application 8 to application 15 do not belong to a same category, and therefore, application 8 to application 15 are separately displayed on the mobile phone.

In this embodiment provided by the present application, after the application adjustment request is received on the terminal, the categorization information of the corresponding applications is acquired to implement categorized display of the application icons, which implements automatic adjustment of display of the application icons according to the categorization information of the applications, thereby reducing an adjustment time for users, and improving user experience.

As an optional solution, the acquiring unit 1004 in this embodiment includes a communications module and an acquiring module.

(1) The communications module is configured to send application identifiers of the applications from the terminal to a server, and receive the categorization information found on the basis of the application identifiers and returned by the server.

Optionally, in this embodiment, categorization information in a database of the terminal is updated and modified if categorization information acquired from the server is different from the categorization information in the database of the terminal.

Optionally, in this embodiment, when the terminal has network connection, the terminal may acquire categorization information of applications, which is requested by the application icon adjustment request, by using the server. For example, as shown in FIG. 2, an application identifier of application 1 on the mobile phone may include an installation package name Apk1 and/or application name AppN1 of application 1, an application identifier of application 2 may include an installation package name Apk2 and/or application name AppN2 of application 2, and an application identifier of application 3 may include an installation package name Apk3 and/or application name AppN3 of application 3. The application identifiers of the foregoing applications are sent from the mobile phone to the server, and the server searches for corresponding categorization information according to the application identifiers, and then returns the obtained categorization information of the applications to the mobile phone.

(2) The acquiring module is configured to acquire the categorization information from a database of the terminal on the basis of application identifiers of the applications.

Optionally, in this embodiment, when the terminal does not have network connection, the terminal acquires the categorization information from the database of the terminal on the basis of the application identifiers of the applications. For example, as shown in FIG. 2, an application identifier of application 1 on the mobile phone may include an installation package name Apk1 and/or application name AppN1 of application 1, an application identifier of application 2 may include an installation package name Apk2 and/or application name AppN2 of application 2, and an application identifier of application 3 may include an installation package name Apk3 and/or application name AppN3 of application 3. Assuming that 5000 pieces of categorization information are stored in the database of the mobile phone, the mobile phone retrieves corresponding application identifiers in the 5000 pieces of categorization information, to find the application identifiers of the foregoing applications, and if the corresponding application identifiers are found, the mobile phone acquires corresponding categorization information according to the application identifiers.

In this embodiment provided by the present application, when network connection is available, the categorization information for categorized display may be acquired by the server through searching on the basis of the application identifiers of the applications; and when network connection is unavailable, the corresponding categorization information is acquired from the database of the terminal on the basis of the corresponding application identifiers. In this way, high accuracy of categorization is ensured when network connection is available, and a high categorization speed is ensured when network connection is unavailable.

As an optional solution, as shown in FIG. 11, the display unit 1006 in this embodiment includes a judging module 1102, a first display module 1104, and a second display module 1106.

(1) The judging module 1102 is configured to determine whether the application icon adjustment request is used for categorized display of all application icons on the terminal.

Optionally, in this embodiment, all application icons may be, but are not limited to, application icons corresponding to all applications already installed on the terminal. For example, as shown in FIG. 2, it is assumed that 15 applications are installed on the mobile phone, namely, application 1 to application 15; application 1, application 2 and application 3 belong to category A, and therefore are categorized into category A, and application icons of application 1, application 2 and application 3 are displayed in a same folder, where the name of the folder may be, but is not limited to, the name of category A (for example, social messaging); application 4, application 5, application 6 and application 7 belong to category B, and therefore are categorized into category B, and application 4, application 5, application 6 and application 7 are displayed in a same folder, where the name of the folder may be, but is not limited to, the name of category B (for example, news); and other applications are separately displayed on the mobile phone. Based on the foregoing condition, after receiving the application icon adjustment request, the mobile phone needs to determine whether the application adjustment request is used for requesting categorized display of application icons of all applications installed on the mobile phone, that is, categorized display of the application icons of application 1 to application 15.

(2) The first display module 1104 is configured to display, if it is determined that the application icon adjustment request is used for categorized display of all application icons on the terminal, the application icons of all the applications on the terminal by category according to the categorization information.

For example, if it is determined that the application icon adjustment request is used for categorized display of all application icons on the terminal, the application icons of the foregoing 15 applications are displayed by category on the terminal according to the acquired categorization information. Specifically, by using categorized display according to the categorization information “whether the application needs network connection” as an example, all the application icons are displayed by category. For example, as shown in FIG. 4, application 1, application 2, and application 9 to application 12 need to be used when network connection is available, and therefore are categorized into category C, and the application icons of application 1, application 2, and application 9 to application 12 are displayed in one folder, where the name of the folder may be, but is not limited to, the name of category C (for example, online applications); application 3 to application 8 can be used without network connection, and therefore are categorized into category D, and the application icons of application 3 to application 8 are displayed in one folder, where the name of the folder may be, but is not limited to, the name of category D (for example, offline applications); the remaining application 13 to application 15 can be used no matter network connection is available or not, and therefore are categorized into category E, and the application icons of application 13 to application 15 are displayed in one folder, where the name of the folder may be, but is not limited to, the name of category E (for example, optional applications). The above is merely an example, and categorized display of all application icons is not limited to being performed according to one type of categorization information; however, categorization principles are the same, and the present application does not provide detailed description herein again.

(3) The second display module 1106 is configured to display, on the terminal by category according to the categorization information, application icons of applications that meet a predetermined condition among all the applications if it is determined that the application icon adjustment request is not used for categorized display of all application icons on the terminal, the predetermined condition including at least one of the following: the application icon of the application is not displayed on a default screen of the terminal, and the application does not belong to any existing category.

Optionally, the predetermined condition in this embodiment includes at least one of the following: the application icon of the application is not displayed on a default screen of the terminal, and the application does not belong to any existing category. Optionally, the default screen in this embodiment may be, but is not limited to, a screen that a user can quickly reach by touching a shortcut key, for example, home screen that the user can reach by touching “HOME”.

Optionally, in this embodiment, when an application on the terminal does not meet the predetermined condition, for example, the application icon of the application is displayed on the default screen of the mobile phone, or the application belongs to an existing category on the mobile phone, the application does not participate in the subsequent categorized display operation, and the original display position is reserved.

For example, if it is determined that the application icon adjustment request is not used for categorized display of all application icons on the mobile phone, and the foregoing applications all meet the predetermined condition, the application icons of the applications that meet the predetermined condition are displayed by category according to the categorization information.

In this embodiment provided by the present application, by determining whether the application icon adjustment request is used for categorized display of all application icons on the terminal, application icons on the terminal are categorized separately according to requirements, thereby providing more display manners for users according to different user requirements.

As an optional solution, the second display module 1106 in this embodiment includes a first determining sub-module, a first judging sub-module, a first display sub-module, and a second display sub-module.

(1) The first determining sub-module is configured to determine, according to the categorization information, a category corresponding to each application that meets the predetermined condition.

Optionally, in this embodiment, each application that meets the condition may correspond to one or more categories. For example, as shown in FIG. 2, applications that meet the predetermined condition are application 8 to application 15, where the categorization information of application 8 to application 15 and the category corresponding to each application meeting the predetermined condition may be as shown in Table 2 below.

TABLE 2

| | Categorization | |
|---|---|---|
| Application | information | Category |
| Application 8 | Category A | Category A |
| | Category B | |
| | Category C | |
| Application 9 | Category B | Category B |
| | Category D | |
| Application 10 | Category A | Category A |
| | Category C | |
| Application 11 | Category A | Category A |
| | Category E | |
| Application 12 | Category E | Category E |
| Application 13 | Category F | Category F |
| Application 14 | Category G | Category G |
| Application 15 | Category H | Category H |

(2) The first judging sub-module is configured to determine whether the categories corresponding to the applications meeting the predetermined condition are the same as an existing category on the terminal.

For example, as shown in FIG. 2, applications meeting the predetermined condition are application 8 to application 15, and it is determined whether categories of these applications are the same as the existing categories on the mobile phone. More specifically, the existing categories on the mobile phone are category A and category B, and it is determined according to the categorization information of application 8 to application 15 that application 8 to application 11 separately belong to the existing category A and category B, while application 12 to application 15 belong to categories that do not exist on the mobile phone.

(3) The first display sub-module is configured to display, if it is determined that the categories corresponding to the applications meeting the predetermined condition are the same as the existing category on the terminal, the application icons of the applications meeting the predetermined condition in a same folder or multiple subfolders of a same folder with application icons in the existing category.

Optionally, in this embodiment, a condition for creating a subfolder includes, but is not limited to, the following two points: first, the number of applications in each subfolder should be greater than a value (for example, 4), and second, the maximum number of subfolders into which a folder is divided should be less than a value (for example, 6). Optionally, multiple applications in a same folder may be displayed in multiple subfolders of the folder in different manners, where the manner includes, but is not limited to: randomly displaying multiple applications, which are in a same folder, in multiple subfolders of the folder, or displaying multiple applications, which are in a same folder, in multiple subfolders of the folder according to an alphabetic order of application names.

For example, as shown in Table 2 and FIG. 6, the categories corresponding to application 8 to application 11 among application 8 to application 15 that meet the predetermined condition are separately the same as category A and category B existing on the mobile phone, and in this case, the application icons of application 8 to application 11 that meet the predetermined condition are each displayed in a same folder or multiple subfolders of a same folder with the application icons in the existing category.

(4) The second display sub-module is configured to display separately an application icon of an application that does not belong to a same category as other applications among the applications meeting the predetermined condition, and display, in a same folder or multiple subfolders of a same folder, application icons of applications that belong to a same category among the applications meeting the predetermined condition, if it is determined that the categories corresponding to the applications meeting the predetermined condition are not the same as the existing category on the terminal.

For example, as shown in Table 2 and FIG. 6, categories corresponding to application 12 to application 15 among application 8 to application 15 that meet the predetermined condition are different from category A and category B existing on the mobile phone, and in this case, application icons of applications that do not belong to a same category as other applications among application 12 to application 15 meeting the predetermined condition are displayed separately, for example, application 14 and application 15 do not belong to a same category as other applications, and therefore are displayed separately. Application icons of applications that belong to a same category among the applications meeting the predetermined condition are displayed in a same folder or multiple subfolders of a same folder. For example, application 12 and application 13 belong to a same category P, while the category P is not an existing category on the terminal, and in this case, the application icons of application 12 and application 13 are displayed in a same folder, and the name of the folder may be, but is not limited to, the name of category P (for example, instant messaging).

In this embodiment of the present application, it is determined whether categories corresponding to the applications meeting the predetermined condition are the same as an existing category on the terminal; if the category of an application is the same as the existing category, the application icon of application is displayed in a same folder with application icons in the existing category, and the application icon of an application that belongs to a different category is displayed separately. In this manner, when display positions of application icons are adjusted, the display positions of the application icons that have been categorized by the user can be reserved, so that the adjustment does not affect the original use habit of the user.

As an optional solution, the second display module 1106 in this embodiment includes:

(1) a second determining sub-module, configured to determine, according to the categorization information, a category corresponding to each application that meets the predetermined condition;

(2) a second judging sub-module, configured to determine whether the categories corresponding to the applications meeting the predetermined condition are the same as an existing category on the terminal; and

(3) a third display sub-module, configured to determine, if the categories corresponding to the applications meeting the predetermined condition are the same as the existing category on the terminal, whether all application icons in the existing category belong to a same category, and display, if all the application icons in the existing categories belong to a same category, the application icons of the applications meeting the predetermined condition in a same folder or multiple subfolders of a same folder with the application icons in the existing category; or display separately an application icon of an application that does not belong to a same category as other applications among the applications meeting the predetermined condition, and display, in a same folder or multiple subfolders of a same folder, application icons of applications that belong to a same category among the applications meeting the predetermined condition, if not all application icons in the existing category belong to a same category; or display separately an application icon of an application that does not belong to a same category as other applications among the applications meeting the predetermined condition, and display, in a same folder or multiple subfolders of a same folder, application icons of applications that belong to a same category among the applications meeting the predetermined condition, if the categories corresponding to the applications meeting the predetermined condition are not the same as the existing category on the terminal.

Optionally, in this embodiment, all applications in the existing category may belong to a same category, for example, as shown in FIG. 2, applications in category A are all player applications; or, not all applications in the existing category belong to a same category, for example, as shown in FIG. 2, applications in category B include different utilities such as communication application and navigation application. Therefore, in this embodiment, it needs to be determined whether all application icons in the existing category belong to a same category.

For example, as shown in FIG. 2 and FIG. 6, if all the application icons in the existing category belong to a same category, for example, all applications in category A are “player applications”, applications that meet the predetermined condition and belong to category A, such as application 8, application 10 and application 11, are displayed in a same folder or multiple subfolders of a same folder with the application icons in the existing category A.

For another example, as shown in FIG. 2 and FIG. 8, not all application icons in the existing category belong to a same category, for example, applications in category B include different utilities such as communication application and navigation application, where an application that meets the predetermined condition, such as application 9, belongs to category B according to the categorization information; however, it needs to be further determined herein whether application 9 belongs to a same category as other applications not participating in the categorization, and if application 9 does not belong to a same category as other applications not participating in the categorization, as shown in FIG. 8, the application icon of application 9 is displayed separately; otherwise, if application 9 belongs to a same category as other applications not participating in the categorization, application 9 is merged with other applications in the same category, and the application icon of application 9 is displayed in a same folder or subfolder as other applications.

In this embodiment provided by the present application, after it is determined whether the categories corresponding to the applications meeting the predetermined condition are the same as an existing category on the terminal, it is further determined whether all application icons in the existing category belong to a same category, and an application meeting the predetermined condition is merged into the existing category only when it belongs to the same category as all application icons in the existing category, so that the adjustment of application icons does not affect an original use habit of a user.

As an optional solution, as shown in FIG. 12, the display unit 1006 in this embodiment includes a determining module 1202, a categorization module 1204, and a third display module 1206.

(1) The determining module 1202 is configured to determine, according to the categorization information, a category corresponding to each application.

For example, as shown in Table 2, it is determined according to the categorization information that application 8, application 10 and application 11 correspond to category A, application 9 corresponds to category B, and application 12 to application 15 separately correspond to category E, category F, category G, and category H.

(2) The categorization module 1204 is configured to categorize the applications into the corresponding categories, where if an application among the applications corresponds to multiple categories, the number of applications in each category of the multiple categories is acquired, and said application is categorized into a category having the largest number of applications among the multiple categories, and if an application among the applications corresponds to one category, said application is categorized into said category.

For example, it is learned before categorized display that, application 1 to application 15 are installed on the mobile phone, where applications meeting the predetermined condition are application 8 to application 15, and categorization information of the eight applications is shown in Table 2. Optionally, in this embodiment, the categorization follows the following principle: define the category that includes the largest number of applications first. It can be learned from Table 2 that, category A includes three applications, namely, application 8, application 10, and application 11; category B includes two applications, namely, application 8 and application 9; category C includes two applications, namely, application 1 and application 10; category D includes one application, namely, application 9; category E includes two applications, namely, application 11 and application 12; and category F to category H each include one application, namely, application 13 to application 15, respectively. It is easy to find that category A includes the largest number of applications, and therefore, category A is defined first. A result of the categorization is as follows: category A (including application 8, application 10, and application 11), and the remaining applications are application 9, application 12, and application 13 to application 15; for application 9, the number of applications in category B is greater than the number of applications in category D, and therefore, the second category, namely, category B, is defined. In this manner, a final categorization result is as shown in the last column of Table 2.

(3) The third display module 1206 is configured to display the applications by category on the terminal according to the categories.

For example, on the basis of the categorization principle described above, the application icons on the mobile phone are displayed by category.

In this embodiment of the present application, the application icons on the terminal are displayed automatically according to the categorization information and on the basis of the predetermined principle, and a category having the largest number of applications is defined first, thereby reducing time for adjusting display of application icons, and bringing convenience to users.

As an optional solution, the third display module 1206 in this embodiment includes:

(1) a fourth display sub-module, configured to display, in a same folder, application icons of applications that belong to a same category having two or more applications; and

(2) a fifth display sub-module, configured to display separately an application icons of an application that belongs to a category having less than two applications.

Optionally, in this embodiment, the number of applications in each category is controlled so as to avoid generating an oversized category or too much categories. For example, as shown in Table 2, the categories corresponding to application 12 to application 15 each include only one application, and in this case, the application icons of these applications may be displayed separately; and for a category that meets the requirement concerning the number of applications, the application icons therein are displayed in a folder denoted by the category.

Optionally, in this embodiment, an existing category may be further divided, to refine the categorization. Moreover, in this embodiment, for a principle and a method for secondary categorization, reference may be made to the primary categorization.

In this embodiment of the present application, by controlling the number of categories and the number of applications in each category, it is ensured that a user can find a needed application quickly within a shortest time; automatic adjustment by a system is implemented, an adjustment time is reduced, and adjustment efficiency is improved.

The sequence numbers of the foregoing embodiments of the present invention are merely for the convenience of description, and do not imply the preference among the embodiments.

In the foregoing embodiments of the present invention, description of each embodiment focuses on a different part, and for a part that is not described in detail in one embodiment, reference may be made to the related description of other embodiments.

In the embodiments provided in the present application, it should be understood that, the disclosed client may be implemented in other manners. The apparatus embodiment described above is merely exemplary. For example, the division of units is merely a division of logical functions, and other division manners may be used in actual implementation. For example, multiple units or components may be combined or integrated into another system, or some features may be ignored or not performed. In addition, the displayed or discussed couplings or direct couplings or communication connections may be indirect couplings or communication connections through some interfaces, apparatuses or units, and may be electric or in other forms.

The units described as separate parts may or may not be physically separate; parts displayed as units may or may not be physical units, which may be located at one position, or distributed over multiple network units. Some or all of the units may be selected according to actual needs to achieve the objectives of the solutions of the embodiments.

In addition, the functional units in the embodiments of the present invention may be integrated into one processing unit, or each unit may exist as an independent physical unit, or two or more units may be integrated into one unit. The integrated unit may be implemented in a form of hardware, and may also be implemented in a form of a software functional unit.

When the integrated unit is implemented in a form of a software functional unit and sold or used as an independent product, the integrated unit may be stored in a computer-readable storage medium. Based on such an understanding, the essence of the technical solutions of the present disclosure, or in other words, the part that makes contributions to the prior art, or some or all of the technical solutions may be implemented in a form of a software product. The computer software product is stored in a storage medium and includes several instructions for instructing a computer device (which may be a personal computer, a server, a network device, or the like) to perform all or some of the steps of the method described in the embodiments of the present invention. The foregoing storage medium includes: any medium that can store program code, such as a USB flash disk, a read-only memory (ROM), a random access memory (RAM), a removable hard disk, a magnetic disk, or an optical disc.

The above descriptions are merely exemplary embodiments of the present invention. It should be noted that, any improvement and modifications made by a person of ordinary skill in the part without departing the principle of the present disclosure shall fall within the protection scope of the present disclosure.

What is claimed is:

1. A method for displaying application icons on a terminal, comprising:
receiving, on a terminal, an application icon adjustment request, the application icon adjustment request being used for requesting categorized display of application icons corresponding to applications installed on the terminal;
acquiring categorization information of the applications in response to the application icon adjustment request; and
displaying, according to the categorization information, the application icons of the applications by category on the terminal.

2. The method according to claim 1, wherein the acquiring categorization information of the applications in response to the application icon adjustment request comprises:
sending application identifiers of the applications from the terminal to a server, and receiving the categorization information found on the basis of the application identifiers and returned by the server; or
acquiring the categorization information from a database of the terminal on the basis of application identifiers of the applications.

3. The method according to claim 1, wherein the displaying, according to the categorization information, the application icons of the applications by category on the terminal comprises:
determining whether the application icon adjustment request is used for categorized display of all application icons on the terminal;
displaying, if it is determined that the application icon adjustment request is used for categorized display of all application icons on the terminal, the application icons of all the applications on the terminal by category according to the categorization information; or
displaying, on the terminal by category according to the categorization information, application icons of applications that meet a predetermined condition among all the applications if it is determined that the application icon adjustment request is not used for categorized display of all application icons on the terminal, the predetermined condition comprising at least one of the following: the application icon of the application is not displayed on a default screen of the terminal, and the application does not belong to any existing category.

4. The method according to claim 3, wherein the displaying, on the terminal by category according to the categorization information, application icons of applications that meet a predetermined condition among all the applications comprises:
determining, according to the categorization information, a category corresponding to each application that meets the predetermined condition;
determining whether the categories corresponding to the applications meeting the predetermined condition are the same as an existing category on the terminal;
displaying, if the categories corresponding to the applications meeting the predetermined condition are the same as the existing category on the terminal, the application icons of the applications meeting the predetermined condition in a same folder or multiple subfolders of a same folder with application icons in the existing category; or
displaying separately an application icon of an application that does not belong to a same category as other applications among the applications meeting the predetermined condition, and displaying, in a same folder or multiple subfolders of a same folder, application icons of applications that belong to a same category among the applications meeting the predetermined condition, if the categories corresponding to the applications that meet the predetermined condition are not the same as the existing category on the terminal.

5. The method according to claim 3, wherein the displaying, on the terminal by category according to the categorization information, application icons of applications that meet a predetermined condition among all the applications comprises:
determining, according to the categorization information, a category corresponding to each application that meets the predetermined condition;
determining whether the categories corresponding to the applications meeting the predetermined condition are the same as an existing category on the terminal;
determining, if the categories corresponding to the applications meeting the predetermined condition are the same as the existing category on the terminal, whether all application icons in the existing category belong to a same category, and displaying, if all the application icons in the existing category belong to a same category, the application icons of the applications meeting the predetermined condition in a same folder or multiple subfolders of a same folder with the application icons in the existing category; or displaying separately an application icon of an application that does not belong to a same category as other applications among the applications meeting the predetermined condition, and displaying, in a same folder or multiple subfolders of a same folder, application icons of applications that belong to a same category among the applications meeting the predetermined condition, if not all application icons in the existing category belong to a same category; or
displaying separately an application icon of an application that does not belong to a same category as other applications among the applications meeting the predetermined condition, and displaying, in a same folder or multiple subfolders of a same folder, application icons of applications that belong to a same category among the applications meeting the predetermined condition, if the categories corresponding to the applications meeting the predetermined condition are not the same as the existing category on the terminal.

6. The method according to claim 1, wherein the displaying, according to the categorization information, the application icons of the applications by category on the terminal comprises:
determining, according to the categorization information, a category corresponding to each application;
categorizing the applications into the corresponding categories, wherein if an application among the applications corresponds to multiple categories, the number of applications in each category of the multiple categories is acquired, and said application is categorized into a category having the largest number of applications among the multiple categories, and if an application among the applications corresponds to one category, said application is categorized into said category; and
displaying the applications by category on the terminal according to the categories.

7. The method according to claim 6, wherein the displaying the applications by category on the terminal according to the categories comprises:
displaying, in a same folder, application icons of applications that belong to a same category having two or more applications; and
displaying separately an application icon of an application that belongs to a category having less than two applications.

8. An apparatus for displaying application icons on a terminal, comprising:
a receiving unit, configured to receive, on a terminal, an application icon adjustment request, the application icon adjustment request being used for requesting categorized display of application icons corresponding to applications installed on the terminal;
an acquiring unit, configured to acquire categorization information of the applications in response to the application icon adjustment request; and
a display unit, configured to display, according to the categorization information, the application icons of the applications by category on the terminal.

9. The apparatus according to claim 8, wherein the acquiring unit comprises:
a communications module, configured to send application identifiers of the applications from the terminal to a server, and receive the categorization information found on the basis of the application identifiers and returned by the server; or
an acquiring module, configured to acquire the categorization information from a database of the terminal on the basis of application identifiers of the applications.

10. The apparatus according to claim 8, wherein the display unit comprises:
a judging module, configured to determine whether the application icon adjustment request is used for categorized display of all application icons on the terminal;
a first display module, configured to display, if it is determined that the application icon adjustment request is used for categorized display of all application icons on the terminal, the application icons of all the applications on the terminal by category according to the categorization information; and
a second display module, configured to display, on the terminal by category according to the categorization information, application icons of applications that meet a predetermined condition among all the applications if it is determined that the application icon adjustment request is not used for categorized display of all application icons on the terminal, the predetermined condition comprising at least one of the following: the application icon of the application is not displayed on a default screen of the terminal, and the application does not belong to any existing category.

11. The apparatus according to claim 10, wherein the second display module comprises:
a first determining sub-module, configured to determine, according to the categorization information, a category corresponding to each application that meets the predetermined condition;
a first judging sub-module, configured to determine whether the categories corresponding to the applications meeting the predetermined condition are the same as an existing category on the terminal;
a first display sub-module, configured to display, if it is determined that the categories corresponding to the applications meeting the predetermined condition are the same as the existing category on the terminal, the application icons of the applications meeting the predetermined condition in a same folder or multiple subfolders of a same folder with application icons in the existing category; and
a second display sub-module, configured to display separately an application icon of an application that does not belong to a same category as other applications among the applications meeting the predetermined condition, and display, in a same folder or multiple subfolders of a same folder, application icons of applications that belong to a same category among the applications meeting the predetermined condition, if it is determined that the categories corresponding to the applications meeting the predetermined condition are not the same as the existing category on the terminal.

12. The apparatus according to claim 10, wherein the second display module comprises:
a second determining sub-module, configured to determine, according to the categorization information, a category corresponding to each application that meets the predetermined condition;
a second judging sub-module, configured to determine whether the categories corresponding to the applications meeting the predetermined condition are the same as an existing category on the terminal;
a third display sub-module, configured to determine, if the categories corresponding to the applications meeting the predetermined condition are the same as the existing category on the terminal, whether all application icons in the existing category belong to a same category, and display, if all the application icons in the existing category belong to a same category, the application icons of the applications meeting the predetermined condition in a same folder or multiple subfolders of a same folder with the application icons in the existing category; or display separately an application icon of an application that does not belong to a same category as other applications among the applications meeting the predetermined condition, and display, in a same folder or multiple subfolders of a same folder, application icons of applications that belong to a same category among the applications meeting the predetermined condition, if not all application icons in the existing category belong to a same category; or display separately an application icon of an application that does not belong to a same category as other applications among the applications meeting the predetermined condition, and display, in a same folder or multiple subfolders of a same folder, application icons of applications that belong to a same category among the applications meeting the predetermined condition, if the categories corresponding to the applications meeting the predetermined condition are not the same as the existing category on the terminal.

13. The apparatus according to claim 8, wherein the display unit comprises:
a determining module, configured to determine, according to the categorization information, a category corresponding to each application;
a categorization module, configured to categorize the applications into the corresponding categories, wherein if an application among the applications corresponds to multiple categories, the number of applications in each category of the multiple categories is acquired, and said application is categorized into a category having the largest number of applications among the multiple categories, and if an application among the applications corresponds to one category, said application is categorized into said category; and
a third display module, configured to display the applications by category on the terminal according to the categories.

14. The apparatus according to claim 13, wherein the third display module comprises:
a fourth display sub-module, configured to display, in a same folder, application icons of applications that belong to a same category having two or more applications; and
a fifth display sub-module, configured to display separately an application icon of an application that belongs to a category having less than two applications.
